(19) United States
(12) Patent Application Publication
(10) Pub. No.: US 2025/0246662 A1
(43) Pub. Date: Jul. 31, 2025

(54) POSITIONING DEVICE

(71) Applicant: HONDA MOTOR CO., LTD., Tokyo (JP)

(72) Inventors: Ryo TAKANO, Saitama (JP); Takeshi OHORI, Saitama (JP); Masahiro HATAOKA, Saitama (JP)

(21) Appl. No.: 19/033,487

(22) Filed: Jan. 22, 2025

(30) Foreign Application Priority Data
Jan. 29, 2024 (JP) 2024-011058

(51) Int. Cl. H01M 8/2404

(52) U.S. Cl. CPC H01M 8/2404

(57) ABSTRACT

Provided is a positioning device that is capable of enhancing energy efficiency by enhancing the work efficiency in the positioning and holding of fuel cells when stacking the fuel cells. This positioning device for a stacking device 1 for fuel cells FC to form a fuel battery includes: a bar holder 60 for stacking the fuel cells FC; and positioning bars 71 that are detachably held by the bar holder 60 and hold the fuel cells FC to be stacked, wherein the bar holder 60 is configured to be dividable.

This application is based on and claims the benefit of priority from Japanese Patent Application No. 2024-011058, filed on 29 Jan. 2024, the content of which is incorporated herein by reference.

### BACKGROUND OF THE INVENTION

### Field of the Invention

The present invention relates to a positioning device.

### Related Art

Stacking devices that have a positioning device for positioning and stacking a plurality of fuel cells to form a fuel cell stack have conventionally been known (see Patent Document 1).

Patent Document 1: Japanese Unexamined Patent Application, Publication No. 2016-157521

### SUMMARY OF THE INVENTION

With respect to the stacking device, the entirety of a cell attitude changer at the upper portion of the stacking device needs to be removed after the fuel cells are stacked, and the work efficiency in manufacture has been required to be enhanced. An object of the present invention is to provide a positioning device that is capable of enhancing energy efficiency by enhancing the work efficiency in the positioning and holding of fuel cells when stacking the fuel cells.

In order to attain the object noted above, provided is a positioning device for positioning a plurality of fuel cells (e.g., “fuel cells FC” described hereinafter) when stacking the fuel cells, the positioning device including: a bar holder (e.g., “bar holder 60” described hereinafter) for stacking the fuel cells; and a positioning bar (e.g., “positioning bar 71” described hereinafter) that is detachably held by the bar holder and holds the fuel cells to be stacked, wherein the bar holder is configured to be dividable.

In the invention noted above, it is preferable that the bar holder is configured to be dividable into pieces spaced apart from each other in a direction orthogonal to the stacking direction of the fuel cells. It is also preferable that the positioning bar has an engager (e.g., “recessed part 711” described hereinafter) configured to be engageable with an engagement receiver (e.g., “protruding part FCΦ2” described hereinafter) formed at a peripheral section of each of the fuel cells.

Furthermore, it is preferable that: the positioning bar is fixed by being coupled to an in-case bar (e.g., “in-case bar 12” described hereinafter) provided in a stack case (e.g., “stack case 10” described hereinafter) accommodating the stacked fuel cells; and the in-case bar has an in-case bar engager (e.g., “recessed part 121” described hereinafter) continuous with the engager (e.g., “recessed part 711” described hereinafter) of the positioning bar.

The present invention can provide a positioning device that is capable of enhancing energy efficiency by enhancing the work efficiency in the positioning and holding of fuel cells when stacking the fuel cells.

### BRIEF DESCRIPTION OF THE DRAWINGS

FIG. 1 illustrates a stacking device according to present embodiments;

FIG. 2 illustrates the appearances of early-stage stacking and middle-stage stacking in the stacking of fuel cells performed by the stacking device according to present embodiments;

FIG. 3 is a flowchart illustrating control performed by the control device of the stacking device according to present embodiments;

FIG. 4 is a perspective view illustrating a situation in which a bar holder and positioning bars are attached to the upper-edge opening section of the stack case of the stacking device according to present embodiments;

FIG. 5 is a plan view illustrating a situation in which the bar holder and the positioning bars are attached to the upper-edge opening section of the stack case of the stacking device according to present embodiments;

FIG. 6 is an upper-portion side view illustrating a situation in which the bar holder and the positioning bars are attached to the upper-edge opening section of the stack case of the stacking device according to present embodiments;

FIG. 7 is a plan view illustrating a first bar holder division of the bar holder of the stacking device according to present embodiments;

FIG. 8 is a plan view illustrating a second bar holder division of the bar holder of the stacking device according to present embodiments;

FIG. 9 is a front view illustrating the positioning bar of the stacking device according to present embodiments;

FIG. 10 is a side view illustrating the positioning bar of the stacking device according to present embodiments; and

FIG. 11 is a plan view illustrating the positioning bar of the stacking device according to present embodiments.

### DETAILED DESCRIPTION OF THE INVENTION

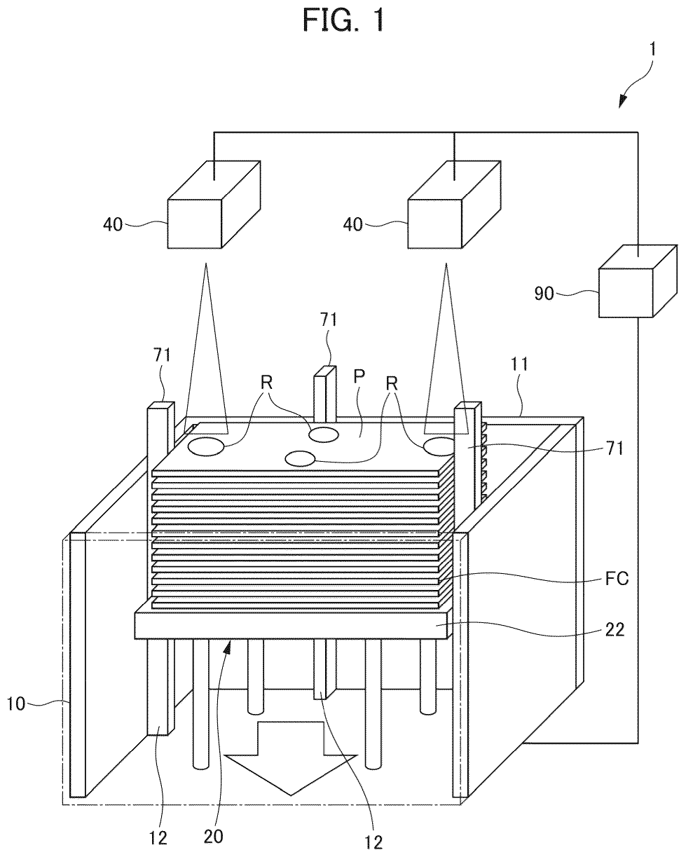

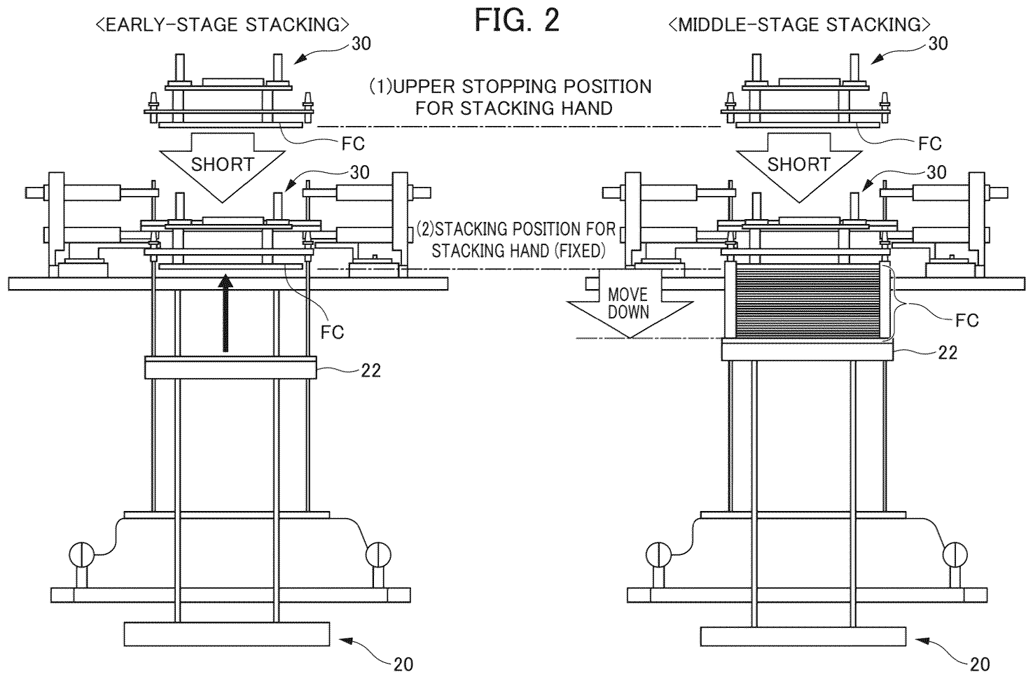

The following describes embodiments of the present invention. As depicted in, for example, FIGS. 1 and 2, a stacking device 1 for fuel cells FC stacks a plurality of fuel cells FC and is provided with a stack case 10, an adjustment device 20, a stacking hand 30 (see, for example, FIG. 2), measurement devices 40, and a control device 90.

The stack case 10 is configured to be shaped like a box assuming a cuboid shape that has an upper opening section 11 making the entirety of the upper surface of the stack case 10 have an opening. A plate-shaped pin lifter 22 forming the adjustment device 20 is disposed in a horizontal state in the stack case 10. The fuel cells FC can be placed on the upper surface of the pin lifter 22. The plurality of fuel cells FC, which are shaped like a rectangular plate and horizontally supported, are inserted through the upper opening section 11 of the stack case 10, and stacked in the stack case 10.

The pin lifter 22 is connected to a servo motor forming the adjustment device 20, which is provided on the lower side in the stack case 10 (see, for example, FIG. 2). Driving the servo motor allows the pin lifter 22 to move in the up-down direction in the stack case 10. On the basis of an elevation amount calculated by a calculation unit of the control device 90, the adjustment device 20 adjusts the height of a stacking surface P, which is the uppermost surface of fuel cells FC to be stacked.

In-case bars 12 are provided in the stack case 10. The in-case bars 12 are disposed at the middle portions, in the horizontal direction, of the four side walls of the stack case 10 having a cuboid shape, in such a manner as to achieve a positional relationship in which the longitudinal direction of the in-case bars 12 is oriented in the up-down direction. For the purpose of description, the illustration of the side wall on the front side from among the four side walls of the stack case 10 having a cuboid shape is omitted in FIG. 1.

In a state of engaging protruding parts FCΦ2, which are engagement receivers formed on the respective four edges of each of the rectangular fuel cells FC inserted into the stack case 10, the in-case bars 12 guide the movement of the fuel cells FC in the up-down direction in the stack case 10, and position the fuel cells FC in the stack case 10.

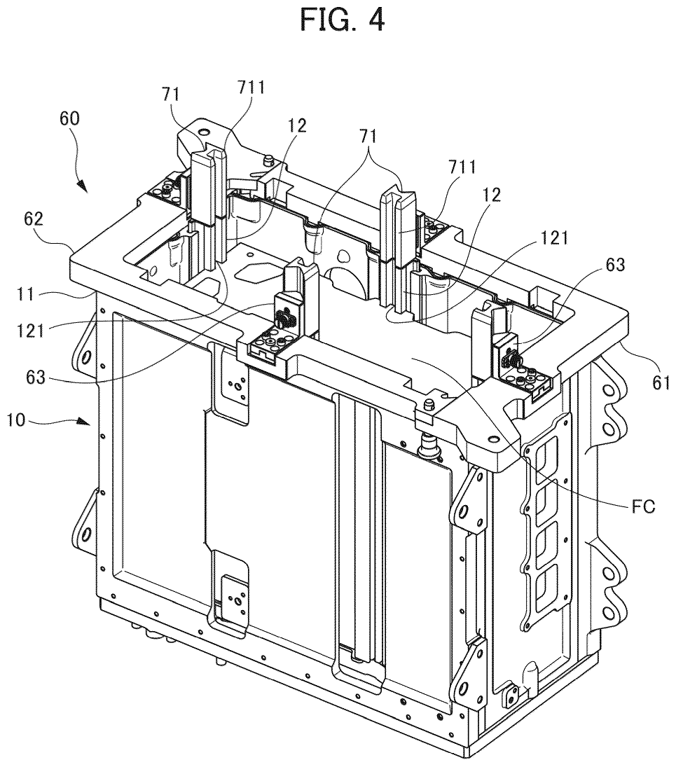

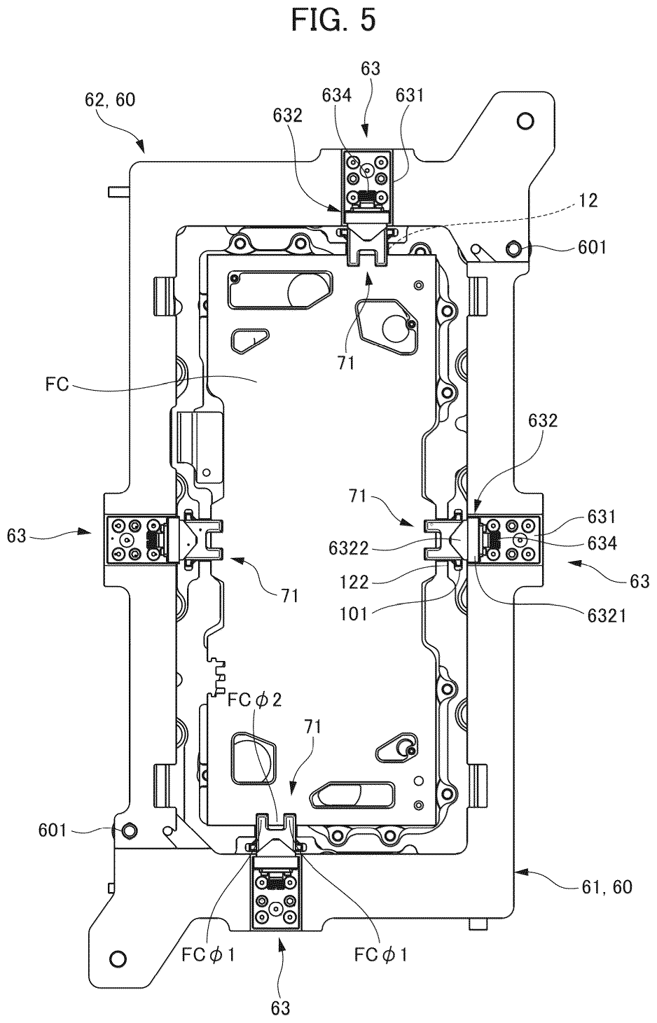

The upper opening section 11 of the stack case 10 has fixed thereto a bar holder 60 (see, for example, FIG. 4), which is shaped like a rectangular plate covering the area above the opening section and serves to stack the fuel cells FC. Positioning bars 71 are held by being detachably fixed to the bar holder 60. The in-case bars 12 are each fixed to the stack case 10 by a pair of protruding parts 122 (see FIG. 5) engaging a guide rail 101 provided on the stack case 10.

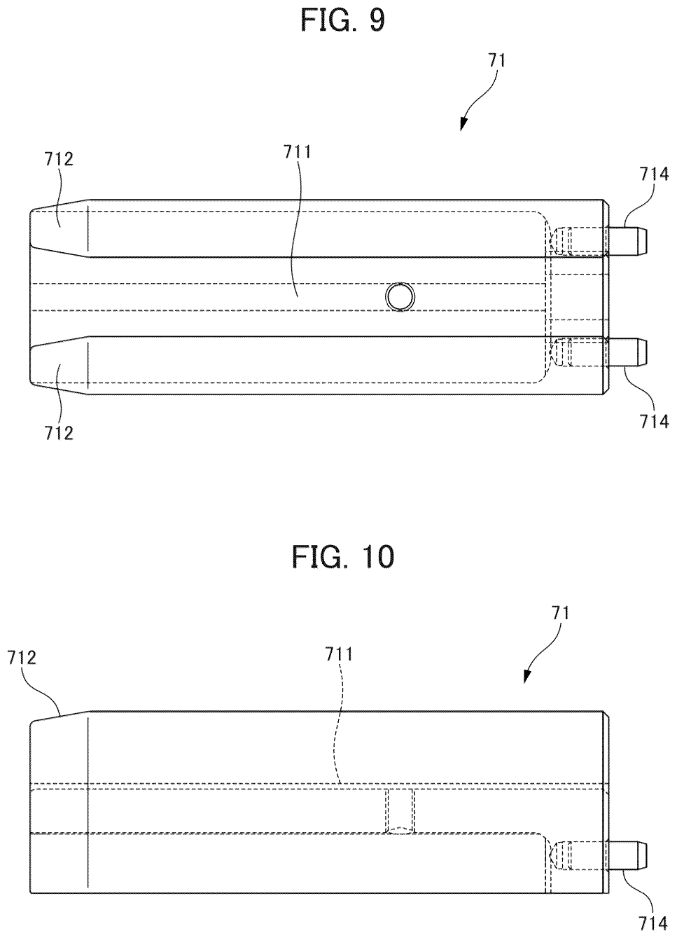

The positioning bars 71 are in a positional relationship in which the lower end surfaces of the positioning bars 71 face the upper end surfaces of the in-case bars 12, as if the in-case bars 12 extended upward. Protruding parts 714 (see, for example, FIG. 9) (described hereinafter) of the positioning bars 71 are fitted into recessed parts (not illustrated) formed in the upper end surfaces of the in-case bars 12, such that the positioning bars 71 are fixed and coupled to the in-case bars 12. The positioning bars 71 are also fixed to the bar holder 60. Details of the bar holder 60 and the positioning bars 71 are described hereinafter. The fuel cells FC are guided and positioned by the positioning bars 71 and then guided to the in-case bars 12, and are guided by the in-case bars 12 and then stacked on the pin lifter 22 in the stack case 10.

The stacking hand 30 transports the fuel cells FC while horizontally supporting the same. The stacking hand 30 is configured to insert the transported fuel cells FC through the upper opening section 11 of the stack case 10 while maintaining the horizontal state, and then stack the fuel cells FC one by one onto the pin lifter 22 in the stack case 10.

The measurement devices 40 each have a distance sensor having a laser emission unit. The distance sensor can measure the height of the stacking surface P, i.e., the uppermost surface of the fuel cells FC to be stacked, in a noncontact manner, i.e., without contacting the stacking surface P. Specifically, the distance sensor is configured to emit a laser to the stacking surface P and receives reflected laser light, so as to sense the space between the laser emission unit and the stacking surface P and output the height of the stacking surface P. The laser light to be used is not particularly limited, but, for example, infrared laser light is employed as the same in present embodiments.

Four measurement devices 40 are provided. Note that FIG. 1 depicts only two measurement devices 40 for convenience of description. As indicated in FIG. 1, four measurement devices 40 are disposed directly above the stacking surface P, i.e., the uppermost surface of the fuel cells FC to be stacked. The measurement devices 40 are configured to measure and output the height of portions R of the stacking surface P of the fuel cells FC that are in the vicinity of the portions of the stacking surface P positioned by abutting the four positioning bars 71.

The control device 90 forms a calculation unit and is formed from, for example, a storage medium such as a central processing unit (CPU), a volatile memory, and/or a nonvolatile memory. The control device 90 is electrically connected to, for example, the servo motor of the adjustment device 20 and the distance sensors of the measurement devices 40, receives the input of a signal output from the distance sensors of the measurement devices 40, and outputs, to the servo motor of the adjustment device 20, a signal for driving the servo motor.

The control device 90 receives the input of signals that are output from the distance sensors of the measurement devices 40 and include values for the height of the stacking surface P, so as to calculate an elevation amount for maintaining the stacking surface P at a prescribed height. Specifically, the control device 90 receives the input of signals from the four measurement devices 40 that include values for the height of the stacking surface P, and calculates the average of these values. Then, the control device 90 calculates the value of the difference between the prescribed height and the average as the elevation amount. In particular, the elevation amount means an amount by which, when the height of the stacking surface P is different from a prescribed position, the pin lifter 22 is moved by raising/lowering the pin lifter 22 in order to match the height of the stacking surface P with the prescribed height.

Next, descriptions are given of details of the feature of supporting the positioning bars 71 by using the bar holder 60. The bar holder 60 and the positioning bars 71 form a positioning device for the fuel cells FC, the positioning device forming the stacking device 1 for the fuel cells FC.

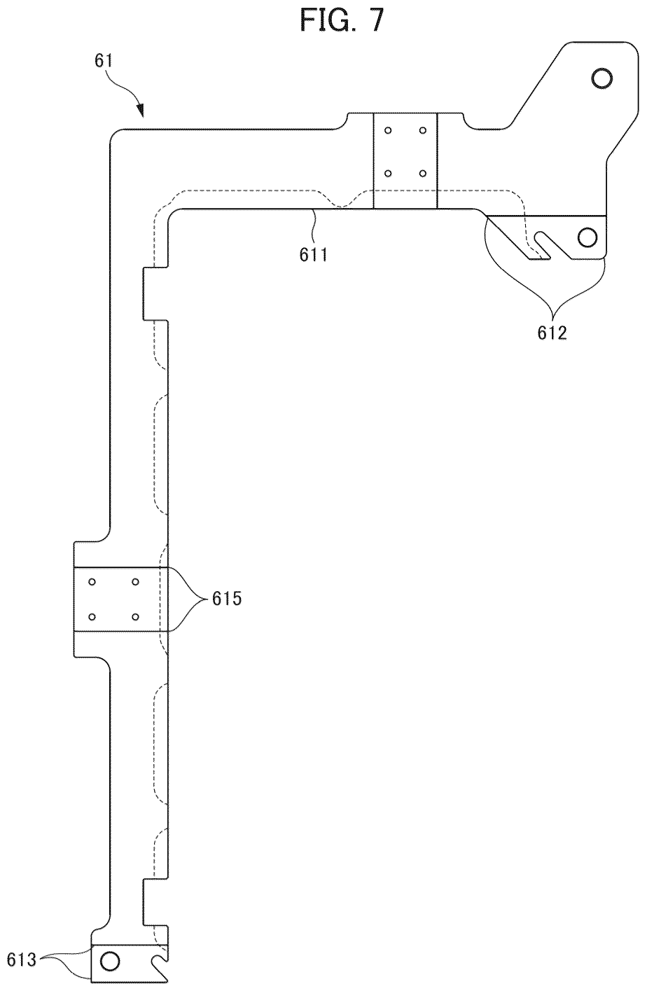

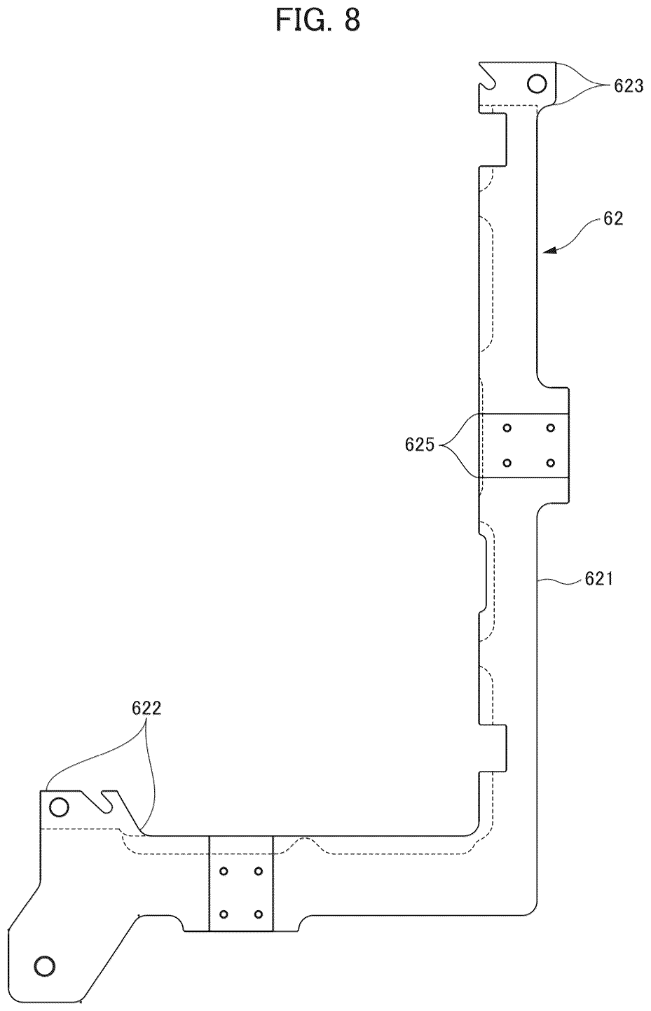

As indicated in FIGS. 7 and 8, the bar holder 60 is formed in a rectangular plate shape by coupling a pair of first bar holder division 61 and second bar holder division 62, which are each shaped like an L-shaped plate, and is configured to be dividable into two pieces spaced apart from each other in the horizontal direction, i.e., a direction orthogonal to the stacking direction of the fuel cells FC. As depicted in FIGS. 4 and 5, the bar holder 60 is fixed to the upper opening section 11 of the stack case 10.

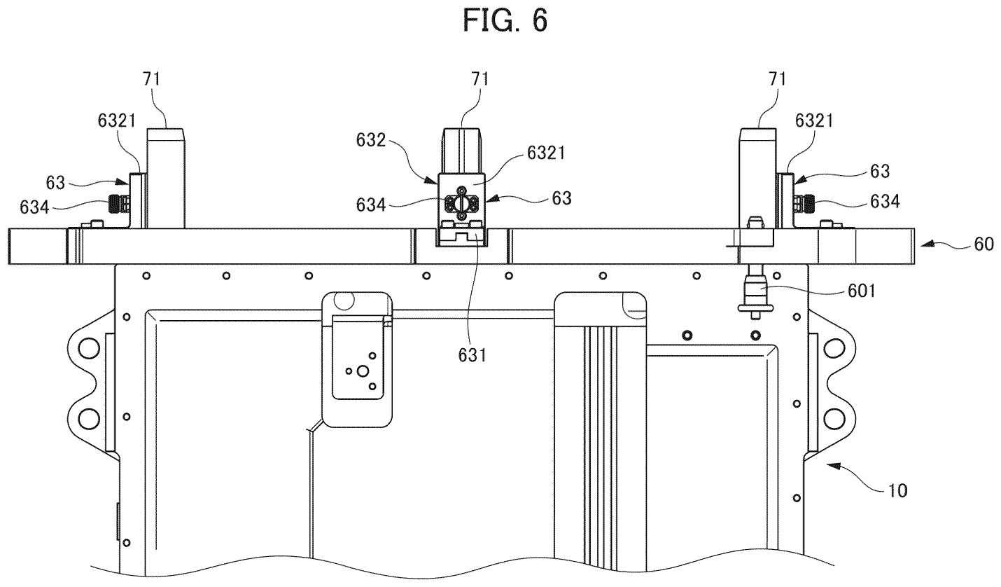

Specifically, the first bar holder division 61 has: a coupling protruding part 612 having half the thickness of a body section 611; and a coupling end section 613. The second bar holder division 62 has: a coupling protruding part 622 having half the thickness of a body section 621; and a coupling end section 623. The coupling protruding part 612 and the coupling end section 623 are placed on each other, the coupling protruding part 622 and the coupling end section 613 are placed on each other, and these sections are fixed to each other by screws 601 (see FIG. 6) such that the pair of first bar holder division 61 and second bar holder division 62 are coupled, thereby assuming the shape of a plate in the form of a rectangular frame.

Bar fixation parts 63 are fixed to the bar holder 60 by screws 634. One bar fixation part 63 is fixed to each of the middle portions of the two edges of each of the first bar holder division 61 and the second bar holder division 62 having an L-shape, i.e., four bar fixation parts 63 are fixed. The bar fixation parts 63 each have a base section 631 and an upper extension section 632.

The base sections 631 are fixed to the first bar holder division 61 and the second bar holder division 62 by engaging recessed parts 615 and recessed parts 625 formed in the upper surfaces of the first bar holder division 61 and the second bar holder division 62. As depicted in FIG. 5, the upper extension sections 632 each have: an outer section 6321 having a cuboid shape and extending upward from the edge section, on the central side, of the bar holder 60 shaped like a rectangular plate; and a triangular-shaped section 6322 molded integrally with the outer section and protruding toward the center of the bar holder 60 shaped like a rectangular plate, while assuming a triangular shape in a plan view.

The positioning bars 71 are fixed to the bar fixation parts 63. Specifically, as depicted in FIGS. 9-11, the positioning bars 71 have a cuboid shape elongated in the up-down direction. A recessed part 711 is formed in the middle position on the side surface of each of the positioning bars 71 on the center side of the bar holder 60 shaped like a rectangular plate, the recessed part 711 serving as an engager having a quadrangular-prism shape formed in such a manner as to extend from one end section to the other end section of the positioning bar 71 in the longitudinal direction.

As depicted in FIGS. 9 and 10, tapered surfaces 712 tapered upward are provided on the portions of the upper end section of the positioning bar 71 between which the recessed part 711 is interposed, i.e., the portions in which the recessed part 711 is not formed. The protruding part FCΦ2 (see FIG. 5), which is an engagement receiver between a pair of recessed parts FCΦ1 that are formed in a middle section of each of the four edges constituting the peripheral sections of the rectangular fuel cell FC, is guided by the tapered surfaces 712 and can be easily inserted into and engage the recessed part 711 serving as the engager.

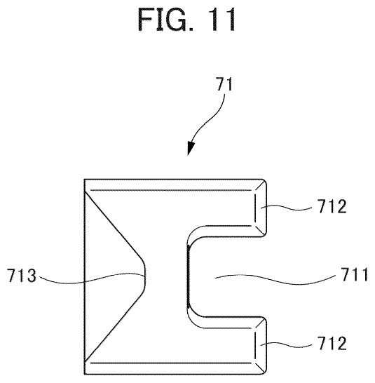

The central portion of the side surface of each of the positioning bars 71 on the opposite side from the center side of the bar holder 60 having the shape of a plate in the form of a rectangular frame has formed therein a triangular-shaped recessed part 713 (see FIG. 11) that can be engaged by the triangular-shaped section 6322 of the bar fixation part 63 and has the same shape as the triangular-shaped section 6322 when viewed in a plan view. As depicted in FIGS. 9 and 10, the lower end section of the positioning bar 71 is provided with a pair of protruding parts 714.

The pair of protruding parts 714 are fitted into the unillustrated recessed parts formed in the upper end surfaces of the in-case bars 12, the triangular-shaped sections 6322 engage the triangular-shaped recessed parts 713, and the screws 634 (see FIG. 6), which penetrate the bar fixation parts 63 in the horizontal direction, fix the portions of the positioning bars 71 forming the bottom sections of the recessed parts 711 to the bar fixation parts 63, with the result that the positioning bars 71 are fixed to the first bar holder division 61, the second bar holder division 62, and the in-case bars 12. As a result of the fixation, as depicted in FIG. 4, in-case bar engagers that are formed in the in-case bars 12 and each have a recessed part 121 having the same shape as the recessed parts 711 are continuous with the engagers of the positioning bars 71 having the recessed parts 711.

When the stacking hand 30 transports one fuel cell FC to the stacking device 1 that is provided with the positioning device having the configuration described above, and inserts the one fuel cell FC through the upper opening section 11 of the stack case 10 while maintaining the horizontal state, each one of the four protruding parts FCΦ2 (see FIG. 5) of the fuel cell FC is inserted into the recessed part 711 of one of the four positioning bars 71 and positioned by engaging this recessed part, and is guided in the downward direction and thus moves down while maintaining the fuel cell FC in the horizontal state.

Further moving down the fuel cell FC causes the protruding parts FCΦ2, which have been inserted into the recessed parts 711 and positioned by engaging the recessed parts, to be positioned by engaging the recessed parts 121 of the in-case bars 12 and guided in the downward direction and thus moves down while maintaining the fuel cell FC in the horizontal state. Then, the fuel cell FC that is moving down is placed onto the pin lifter 22 or onto a fuel cell FC, if any, already placed on the pin lifter 22, thereby stacking the fuel cell FC.

After the stacking of a prescribed number of fuel cells FC is completed, the screws 601 and 634 are loosened and removed, such that the coupling between the pair of first bar holder division 61 and second bar holder division 62 is released, and the bar fixation parts 63 are removed from the positioning bars 71. Specifically, the bar holder 60 is divided into the first bar holder division 61 and the second bar holder division 62, i.e., divided into two pieces spaced apart from each other in the horizontal direction, which is orthogonal to the stacking direction of the fuel cells FC, and is removed from the stack case 10 accommodating the stacked fuel cells FC.

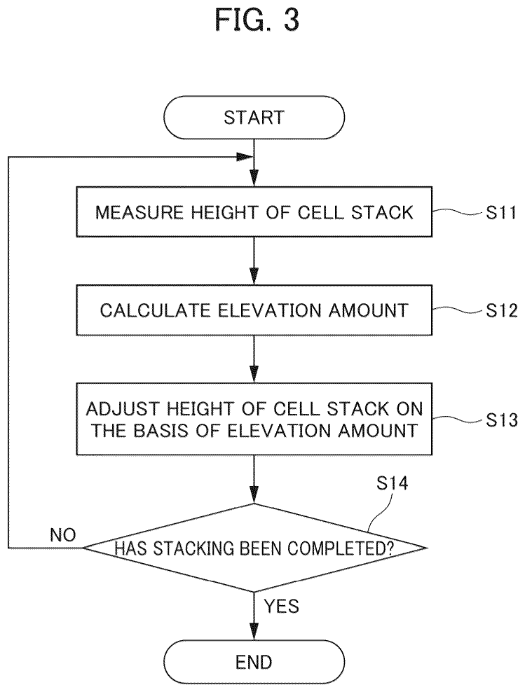

Next, the control for raising/lowering the pin lifter 22 performed by the control device 90 is described by referring to the flowchart indicated in FIG. 3. First, in step S11, the control device 90 performs, with respect to the distance sensors of the four measurement devices 40, control for measuring the height of the stacking surface P. Then, the control performed by the control device 90 shifts to step S12.

Subsequently, in step S12, the control device 90 receives the input of four values, namely, the values of the heights of four portions R of the stacking surface P from the four measurement devices 40, and calculates the average of these four values. Afterwards, the control device 90 calculates the value of the difference between a prescribed value and the average, and defines the value of the difference as an elevation amount. Then, the control performed by the control device 90 shifts to step S13.

Next, in step S13, the control device 90 performs, with respect to the servo motor of the adjustment device 20, control for adjusting the position of the pin lifter 22 on the basis of the elevation amount such that the value of the height of the stacking surface P matches the prescribed value.

Specifically, when the average of the heights of the portions of the stacking surface P is higher than the prescribed value (see the “MIDDLE-STAGE STACKING” in FIG. 2), the control device 90 performs, with respect to the servo motor of the adjustment device 20, control for lowering the pin lifter 22 by the elevation amount by driving the servo motor. When the average of the heights of the portions of the stacking surface P is lower than the prescribed value (see the “EARLY-STAGE STACKING” in FIG. 2), the control device 90 performs, with respect to the servo motor of the adjustment device 20, control for raising the pin lifter 22 by the elevation amount by driving the servo motor. In this way, the average of the heights of the portions of the stacking surface P matches the prescribed value. Then, the control performed by the control device 90 shifts to step S14.

Subsequently, in step S14, the control device 90 determines whether the stacking of fuel cells FC has been completed, i.e., whether a prescribed number of fuel cells FC have finished being stacked. When the stacking of fuel cells FC has been completed (S14: YES), the processing preformed by the control device 90 ends.

When the stacking of fuel cells FC has not been completed (S14: NO), the control device 90 transports one fuel cell FC anew to the stacking hand 30 and performs control for inserting the fuel cell FC through the upper opening section 11 of the stack case 10 while maintaining the horizontal state. Afterward, the control device 90 performs, with respect to the stacking hand 30, control for placing onto the uppermost fuel cell FC of the fuel cells FC stacked on the pin lifter 22 in the stack case 10. Then, the control performed by the control device 90 returns to step S11, and the processing described above is performed for each of the fuel cells FC to be stacked.

The embodiments described above achieve the following effects. In present embodiments, the positioning device for fuel cells FC, the positioning device forming the stacking device 1 for fuel cells FC, includes: a bar holder 60 for stacking the fuel cells FC; and positioning bars 71 that are detachably held by the bar holder 60 and hold the fuel cells FC to be stacked, wherein the bar holder 60 is configured to be dividable.

Accordingly, the fuel cells FC to be stacked can be positioned and held by the positioning bars 71 while being stacked. Thus, fuel cells FC can be stacked in a state of being positioned and held, so that the stacking of the fuel cells FC can be accelerated. Furthermore, since the positioning bars 71 are detachably held by the dividable bar holder 60, the bar holder 60, after stacking, can be divided and easily removed from the positioning bars 71 and the stacked fuel cells FC. Hence, a lid member can be mounted from above onto the stacked fuel cells FC with the positioning bars 71 remaining on the stacked fuel cells FC.

In present embodiments, the bar holder 60 is configured to be capable of being divided into pieces spaced apart from each other in a direction orthogonal to the stacking direction of fuel cells FC. As a result, the bar holder 60 can be divided and easily removed from the stacked fuel cells FC without being hindered by the positioning bars 71 that remain on the stacked fuel cells FC.

In present embodiments, the positioning bars 71 have recessed parts 711, which are engagers capable of engaging the protruding parts FCΦ2, which are engagement receivers formed at the peripheral sections of the fuel cells FC. Thus, the fuel cells FC can be easily positioned by the recessed parts 711 engaging the protruding parts FCΦ2. The fuel cells FC in a state of being positioned can be guided downward, i.e., guided in the direction in which the fuel cells FC are stacked.

In present embodiments, the positioning bars 71 are fixed by being coupled to the in-case bars 12 provided in the stack case 10 that accommodates stacked fuel cells FC, and the in-case bars 12 have recessed parts 121, which are in-case bar engagers continuous with the recessed parts 711, which are the engagers of the positioning bars 71. Thus, fuel cells FC can move down and thus cause the transition from a state in which the recessed parts 711 engage the protruding parts FCΦ2 to a state in which the recessed parts 121 engage the protruding parts FCΦ2, so that the fuel cells FC can continuously remain positioned and held.

The present invention is not limited to the embodiments described above, and encompasses, for example, variations and improvements with which objects of the present invention can be achieved. For example, the number of measurement devices 40 and the positions at which the same are disposed are not limited to those in the present embodiments. Although the adjustment device 20 has a servo motor, the present invention is not limited to this, and the adjustment device 20 may use another motor or the like.

In present embodiments, the bar holder 60 is formed in a rectangular plate shape by coupling a pair of first bar holder division 61 and second bar holder division 62, which are each shaped like an L-shaped plate, and is configured to be capable of being divided into two pieces. However, the present invention is not limited to this. For example, the bar holder may be capable of being divided into three or more pieces. The number and configuration of positioning bars is not limited to those of the positioning bars 71 in the present embodiments.

### EXPLANATION OF REFERENCE NUMERALS

1: Stacking device (positioning device)
10: Stack case
12: In-case bar
60: Bar holder
71: Positioning bar
121: Recessed part (in-case bar engager)
711: Recessed part (engager)
FCΦ2: Protruding part (engagement receiver)

What is claimed is:

1. A positioning device for positioning a plurality of fuel cells when stacking the fuel cells, the positioning device comprising:
a bar holder for stacking the fuel cells; and
a positioning bar that is detachably held by the bar holder and holds the fuel cells to be stacked, wherein
the bar holder is configured to be dividable.

2. The positioning device according to claim 1, wherein
the bar holder is configured to be dividable into pieces spaced apart from each other in a direction orthogonal to a stacking direction of the fuel cells.

3. The positioning device according to claim 1, wherein
the positioning bar has an engager configured to be engageable with an engagement receiver formed at a peripheral section of each of the fuel cells.

4. The positioning device according to claim 3, wherein
the positioning bar is fixed by being coupled to an in-case bar provided in a stack case that accommodates the stacked fuel cells, and
the in-case bar has an in-case bar engager continuous with the engager of the positioning bar.
